(19) United States
(12) Patent Application Publication
(10) Pub. No.: US 2026/0166680 A1
(43) Pub. Date: Jun. 18, 2026

(54) CLAMP FOR MAINTAINING PRESSURE

(71) Applicant: Wistron NeWeb Corporation, Hsinchu (TW)

(72) Inventors: Jing Jing GONG, Hsinchu (TW); Yu-Fu KUO, Hsinchu (TW); Che Min LIN, Hsinchu (TW); Pingping PU, Hsinchu (TW); Hsiao Chan CHANG, Hsinchu (TW)

(21) Appl. No.: 19/192,454

(22) Filed: Apr. 29, 2025

(30) Foreign Application Priority Data
Dec. 18, 2024 (CN) 202411865607.6

(51) Int. Cl. B25B 5/04; B33Y 80/00

(52) U.S. Cl. CPC B25B 5/04; B33Y 80/00

(57) ABSTRACT

A clamp for maintaining pressure on a component, the clamp including: a cover; a carrier hinged to the cover; a first pressing path control post arranged on the cover and/or the carrier; and a second pressing path control post arranged on the cover and/or the carrier. A height of the first pressing path control post and a height of the second pressing path control post are different from each other.

### RELATED APPLICATION

This application claims the benefit of priority to China Patent Application No. 202411865607.6, filed on Dec. 18, 2024 in People's Republic of China. The entire content of the above identified application is incorporated herein by reference.

### BACKGROUND

### Technical Field

The present disclosure relates to a clamp, particularly a clamp for maintaining pressure.

### Description of Related Art

During the manufacturing process of electronic devices, it is often necessary to assemble different parts of a component together. The assembly process may require various means such as adhesives or ultrasonic welding to attach different parts of the component together. However, the means for attachment that can be used are limited by many factors such as the material, specification requirements, and structure of the component. For example, in the structural design of some notebook computers, tablet computers, or other electronic devices, some components may not withstand high temperatures and are not suitable for ultrasonic welding, so adhesives are used instead. Adhesives need time to set, and pressure needs to be maintained on the component during the waiting process to avoid poor adhesion that does not meet specification requirements. Traditional means for maintaining pressure include pressure-maintaining equipment or spring clamps, but each has its disadvantages. For example, pressure-maintaining equipment is expensive and does not have productive efficiency, while spring clamps cannot control the clamping force, cannot control the location distribution of the applied force, and the spring clamp may easily fall off due to complex curved surfaces of the component. Furthermore, a component may require multiple spring clamps, and in the case of mass production, a large number of spring clamps are needed, making management difficult and it is hard to determine or control whether each spring clamp needs replacement.

Today's electronic product specifications are becoming more stringent, tolerances are becoming smaller, and if the components are not well assembled, it may lead to issues such as assembly size mismatches, air leaks, sound leaks, etc. As the shape of the components becomes more complex, it is difficult for traditional clamping solutions to apply uniform pressures to complex shapes. Moreover, different areas of the same component may require different pressures to allow the adhesive to properly attach the component together. For example, due to various factors such as material and structure, some parts of the component may be more prone to warping or have larger gaps, and these parts require stronger clamping force while waiting for the adhesive to set. Traditional clamping solutions cannot efficiently adjust the pressure for different parts of the same component.

Another problem encountered by traditional clamps is that not all areas need to be pressurized during the adhesive attachment process of the component. In some cases, delicate or fragile elements may be installed on the component, so some areas need to be pressurized while others are not suitable for pressurization. Traditional clamps are unable to effectively separate pressurized areas from non-pressurized areas.

To address the above issues, a clamp is needed that can: apply appropriate pressure to components with complex shapes, apply different levels of pressure to different parts of the same component, avoid areas that are not suitable for pressurization, be cost-effective, and can be mass-produced.

### SUMMARY

In some embodiments, the present disclosure provides a clamp for maintaining pressure on a component, the clamp including: a cover; a carrier, the carrier being hinged to the cover; a first pressing path control post, the first pressing path control post being arranged on the cover and/or the carrier; and a second pressing path control post, the second pressing path control post being arranged on the cover and/or the carrier; wherein a height of the first pressing path control post and a height of the second pressing path control post are different from each other.

### BRIEF DESCRIPTION OF THE DRAWINGS

The described embodiments may be better understood by reference to the following description and the accompanying drawings, in which:

FIG. 1 shows a schematic diagram of a clamp according to an embodiment of the present disclosure.

FIG. 2 shows a schematic diagram of a component according to an embodiment of the present disclosure.

FIG. 3 shows a schematic diagram of a component placed in a clamp according to an embodiment of the present disclosure.

FIG. 4 shows a schematic diagram of a hinge of a clamp according to an embodiment of the present disclosure.

FIG. 5 shows a schematic diagram of a clamp that is clamping a component according to an embodiment of the present disclosure.

FIGS. 6A, 6B, 6C, and 6D show aspects of different pressing path control posts according to an embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Those skilled in the art can understand the advantages and effects of the present disclosure from the content disclosed in this specification. The present disclosure can be implemented or applied through other different embodiments, and the details in this specification can be modified and changed in various ways without departing from the spirit of the present disclosure. Additionally, the drawings of the present disclosure are for simple illustrative purposes and are not drawn to actual scale.

The present disclosure provides a clamp that can apply appropriate pressure to components with complex shapes, and apply different levels of pressure or avoidance to different areas of the same component. The clamp of the present disclosure can be manufactured by injection molding or 3D printing, allowing for rapid and mass production, and reduced manufacturing costs. The material of the clamp can be any material suitable for injection molding or 3D printing. Additionally, the clamp of the present disclosure has high flexibility in terms of design. For example, if it is found that the clamp applies too much or too little pressure to certain areas of the component, then modifications can be made on a structural design software and the clamp can be remade so as to adjust the pressure applied by the clamp to various areas of the component. Alternatively, to hold different types of components, clamps of various shapes can also be designed through software to appropriately clamp different types of components.

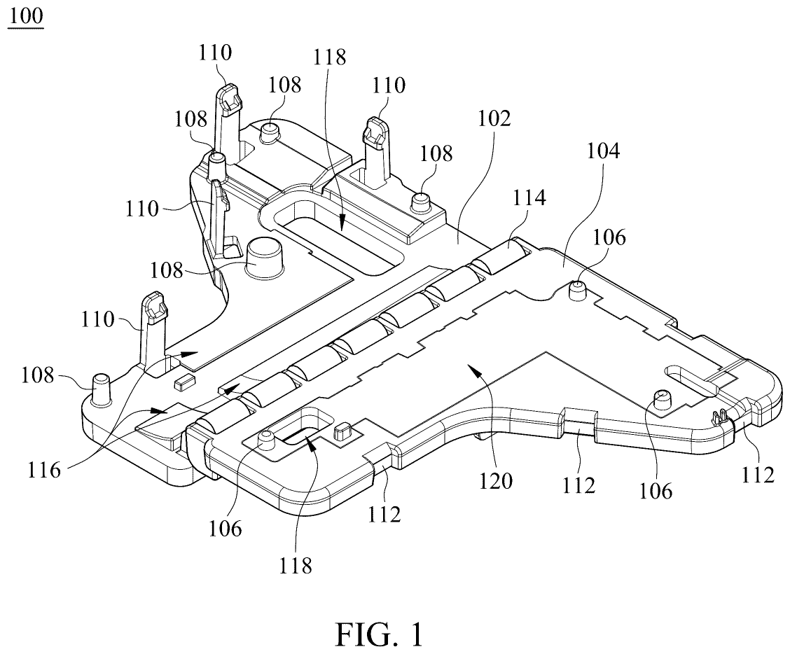

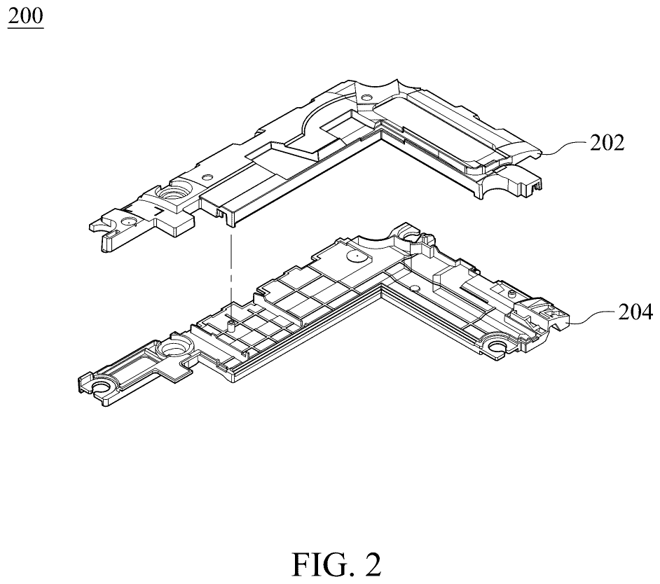

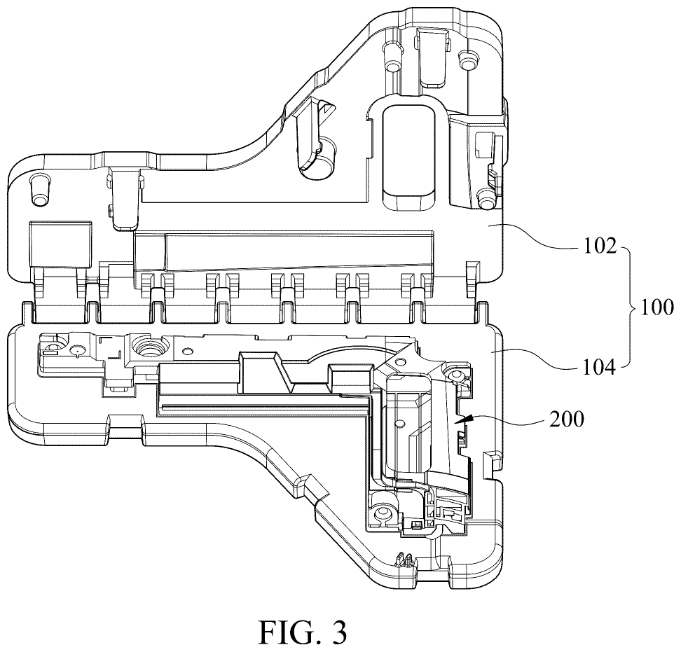

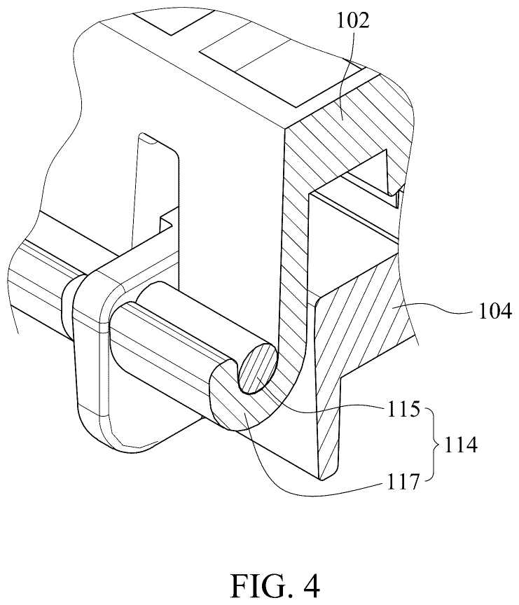

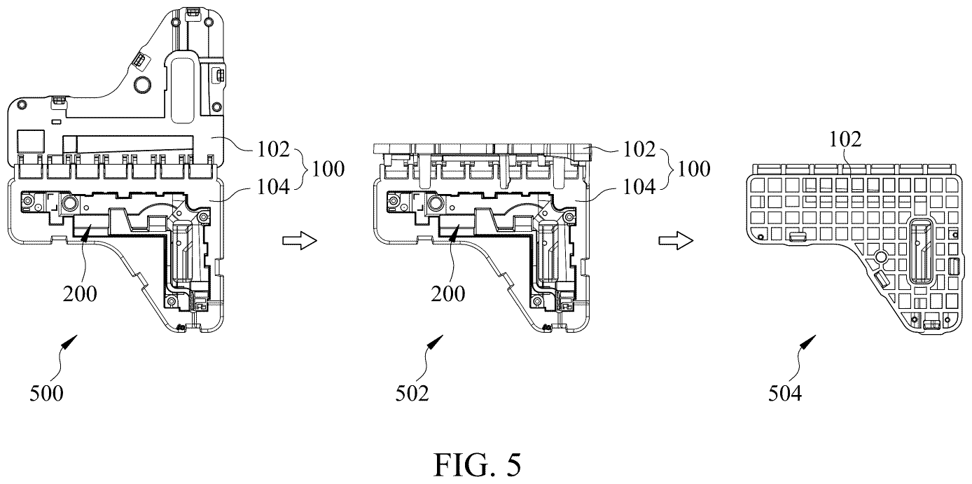

FIGS. 1 to 5 are referred to together. Clamp 100 includes a cover 102 and a carrier 104, wherein the carrier 104 is hinged to the cover 102 via a hinge 114. The hinge 114 includes a shaft 115 and a shaft hook 117, the shaft hook 117 hooks to the shaft 115, such that the carrier 104 is hinged with the cover 102 (as shown in FIG. 4). In the embodiment of FIG. 4, the shaft 115 is arranged on the carrier 104, and the shaft hook 117 is arranged on the cover 102; in variant embodiments, the shaft can be arranged on the cover, and the shaft hook can be arranged on the carrier. The clamp 100 can clamp the component 200 via the cover 102 and the carrier 104. FIG. 2 shows a schematic diagram of a component 200, wherein the component 200 includes a first part 202 and a second part 204. It should be noted that the component 200 is a simplified illustration, and in actual situations, the first part 202 and the second part 204 of the component 200 can have other elements such as antennas, speakers, etc. installed or arranged thereon, but only the first part 202 and the second part 204 are shown, omitting other installed elements for sake of clarity. In an assembly example, the first part 202 and/or the second part 204, as well as any required installed elements (not shown), are first glued, and then the first part 202 and the second part 204 are assembled together. Next, the component 200 is placed on the clamp 100 (as shown in FIG. 3), and the cover 102 and the carrier 104 of the clamp 100 are closed together (as shown in states 500, 502, 504 in FIG. 5) so as to apply pressure to the component 200. During the pressing process, the snap hook 110 and the engaging structure 112 of the clamp 100 are locked together, such that the clamp 100 continuously applies pressure to the component 200 while waiting for the adhesive to set; after waiting for a period of time for the adhesive to set, the component 200 can be removed from the clamp 100. The component 200 can then be installed into a product (such as a notebook computer, tablet computer, etc.). The component 200 shown in FIG. 2 is only an example, and in actual situations, the component 200 can have various shapes. To allow the component 200 to have various elements installed, the shape of the component 200 may be complex and irregular. The clamp 100 can be adjusted in various ways to accommodate the shape of the component 200. Overall, the shapes of the clamp 100 and the component 200 shown in the drawings can vary according to actual situations, and the present disclosure includes such variations.

The structure of the clamp 100 is further described below. In the embodiment of FIG. 1, the clamp 100 includes positioning posts 106 and an accommodation slot 120 to fix the component 200 in position (as shown in FIG. 2). The shape of the accommodation slot 120 can match the component 200, such that the component 200 can be appropriately placed in the accommodation slot 120. The positioning posts 106 are columns used to assist in positioning the component 200; in some embodiments, the component 200 has several holes, and the positions of the positioning posts 106 can match the holes of the component 200, such that when the component 200 is placed on the carrier 104, the positioning posts 106 can pass through the holes of the component 200 to secure its position. Alternatively, the positioning posts 106 can be arranged around the component 200, such that the outer casing of the component 200 abuts against the positioning posts 106 for positioning. In some variant embodiments, the accommodation slot can be omitted, using only the positioning posts for positioning; or the positioning posts can be omitted, using only the accommodation slot for positioning. The snap hook 110 of the clamp 100 can lock onto the engaging structure 112 for maintaining the pressure on the component 200 while the clamp 100 is closed. In the embodiment of FIG. 1, the snap hooks 110 are arranged on the cover 102, while the engaging structures 112 are arranged on the carrier 104; however, in some variant embodiments, the snap hooks can be arranged on the carrier, and the engaging structures can be arranged on the cover. Additionally, the number and position of the snap hooks 110 and the engaging structures 112 can be adjusted as desired. In other variant embodiments, other means can be used to fix the cover and the carrier together; for example, the snap hooks and the engaging structures can be replaced with screws, nuts, or other types of fasteners.

The cover 102 and/or the carrier 104 of the clamp 100 can have an avoidance structure 118 arranged thereon, wherein the avoidance structure 118 is configured to avoid contact with the component 200. In other words, when the component 200 is clamped inside the clamp 100, although the clamp 100 applies pressure to the component 200, the avoidance structure 118 of the clamp 100 can avoid pressing certain parts of the component 200. As previously mentioned, delicate or fragile elements may be disposed on the component 200, hence some areas are not suitable for pressurization, and the clamp 100 can have avoidance structures 118 arranged in those areas to avoid pressing the component 200 when the clamp 100 is closed. The avoidance structure 118 can have various forms; in the embodiment shown in FIG. 1, the avoidance structures 118 are hollowed holes; in some variant embodiments, the avoidance structures can be configured as protrusions or recesses to avoid contact with the component.

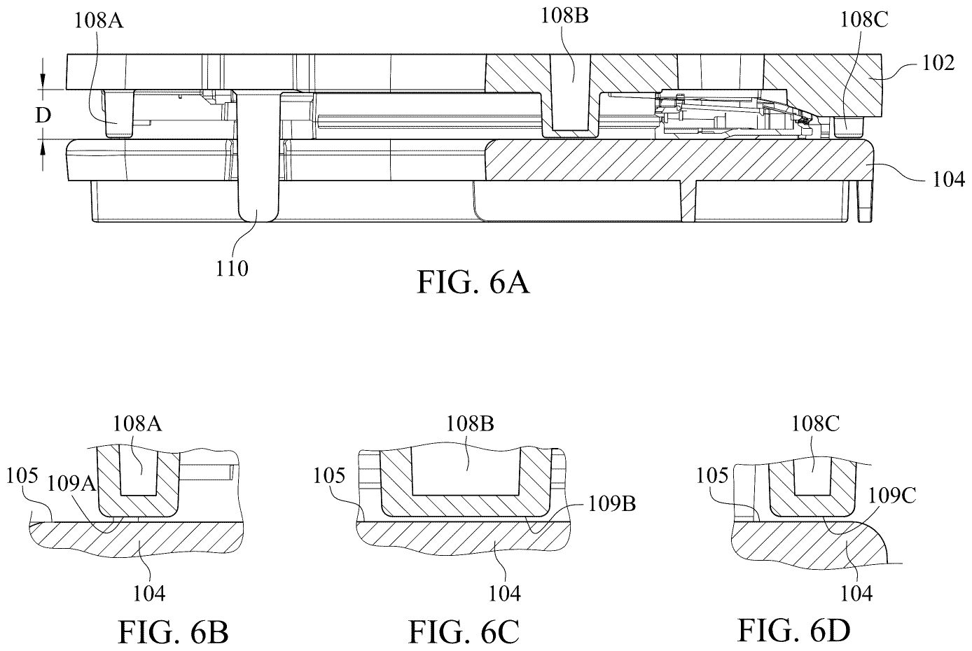

The means for controlling the pressure applied by the clamp 100 to the component 200 is described below. The clamp 100 can control the applied pressure through a component-resembling structure 116 and/or a pressing path control post 108. The shape and/or height of the component-resembling structure 116 is configured to adapt to the component 200. For example, if a portion of the component 200 has a convex arc shape, then the corresponding portion of the component-resembling structure 116 can be configured as a concave arc shape; if a portion of the component 200 has an inclined surface, then the corresponding portion of the component-resembling structure 116 can be configured as the corresponding inclined surface. Since the shape of the component-resembling structure 116 matches the shape of the component 200, the clamp 100 can apply uniform pressure to the complex shape of the component 200. Additionally, the level of pressure applied to the component 200 can be influenced by adjusting the height of the component-resembling structure 116; if the component-resembling structure 116 is higher, the pressure applied to the component 200 is greater when the clamp 100 is closed; if the component-resembling structure 116 is lower, the pressure applied to the component 200 is smaller when the clamp 100 is closed. Component-resembling structures 116 with different shapes and/or heights can be arranged in different areas of the clamp 100 so as to apply different levels of pressure to different areas of the component 200. The clamp 100 can also control the level of pressure applied to the component 200 through the pressing path control post 108. The pressing path control post 108 itself does not directly apply pressure to the component 200, but when the clamp 100 is closed, the pressing path control post 108 can prop up a gap between the cover 102 and the carrier 104; if the pressing path control post 108 is longer, the gap held between the cover 102 and the carrier 104 is larger, and thus the pressure applied to the component 200 is smaller; if the pressing path control post 108 is shorter, the gap held between the cover 102 and the carrier 104 is smaller, and thus the pressure applied to the component 200 is larger. Accordingly, pressing path control posts 108 with different heights can be arranged to control the maximum pressure that the clamp 100 can apply to the component 200 in different areas. The pressing path control post 108 can be arranged on the cover 102 and/or the carrier 104; although FIG. 1 only shows the pressing path control post 108 arranged on the cover 102, the pressing path control post 108 can be arranged on the carrier 104 as needed. Further details of the pressing path control post 108 will be described below in FIGS. 6A-6D.

In the embodiment of FIGS. 6A-6D, the cover 102 is provided with three pressing path control posts 108A, 108B, and 108C. It should be noted that the embodiment of FIGS. 6A-6D is only an example, and fewer or more pressing path control posts 108 can be arranged. The pressing path control posts 108A, 108B, and 108C can have the same or different heights and can be arranged in different areas of the clamp 100. The areas where the pressing path control posts 108A, 108B, and 108C are located can each be viewed as a pressing area, e.g., the clamp 100 can be divided into a first pressing area, a second pressing area and a third pressing area; that is, the pressing path control posts 108A, 108B, and 108C are respectively arranged in the first pressing area, the second pressing area, and the third pressing area of the clamp 100. There is a maximum gap D between the cover 102 and the carrier 104. The lengths of the pressing path control posts 108A, 108B, and 108C can be the same as or different from the maximum gap D so as to control the maximum pressures that the first pressing area, the second pressing area, and the third pressing area can apply to the component 200. For example, as shown in FIGS. 6B-6D, the pressing path control posts 108A, 108B, and 108C respectively have control post surfaces 109A, 109B, and 109C at their ends, a same gap or different gaps can be formed between each control post surface 109A, 109B, and 109C and a carrier surface 105 of the carrier 104, wherein in some examples, the gaps can be 0 mm to 2.0 mm, but the present disclosure is not limited thereto. For example, the gaps between the control post surfaces 109A, 109B, and 109C and the carrier surface 105 are 0.4 mm, 0.2 mm, and 0.2 mm, respectively; these gaps correspond to the space available for pressing in each pressing area. When the clamp 100 is closed, in the first pressing area where the pressing path control post 108A is located, more space is available for pressing between the cover 102 and the carrier 104; while in the second pressing area and the third pressing area where the pressing path control posts 108B and 108C are located, less space is available for pressing between the cover 102 and the carrier 104. Therefore, the first pressing area can apply a greater pressure to the component 200 as compared to the second pressing area and the third pressing area. In some embodiments, the height of one or more of the pressing path control posts 108A, 108B, and 108C can be equal to or less than the maximum gap D between the cover 102 and the carrier 104.

Based on the above, if certain portions of the component 200 are prone to warping or have larger gaps due to various factors such as material and structure, the height of the pressing path control post 108 in the corresponding area of the clamp 100 can be shortened to provide more space for pressing, thereby increasing the pressure applied to the component 200.

The embodiments were chosen and described in order to explain the principles of the present disclosure and their practical applications. Alternative embodiments will become apparent to those skilled in the art to which the present disclosure pertains without departing from its spirit and scope.

What is claimed is:

1. A clamp for maintaining pressure on a component, the clamp comprising:
a cover;
a carrier, the carrier being hinged to the cover;
a first pressing path control post, the first pressing path control post being arranged on the cover and/or the carrier; and
a second pressing path control post, the second pressing path control post being arranged on the cover and/or the carrier;
wherein a height of the first pressing path control post and a height of the second pressing path control post are different from each other.

2. The clamp according to claim 1, wherein the cover and the carrier have a maximum gap therebetween, the height of the first pressing path control post is less than or equal to the maximum gap, and the height of the second pressing path control post is less than the maximum gap.

3. The clamp according to claim 1, wherein the clamp is divided into a first pressing area and a second pressing area, the first pressing path control post is arranged in the first pressing area, the second pressing path control post is arranged in the second pressing area, and the first pressing path control post and the second pressing path control post are configured to allow the first pressing area and the second pressing area to apply different maximum pressures to the component.

4. The clamp according to claim 3, wherein the first pressing path control post and the second pressing path control post do not directly apply pressure to the component.

5. The clamp according to claim 1, wherein the carrier further comprises a shaft, and the cover further comprises a shaft hook, the shaft hook hooks to the shaft such that the carrier is hinged with the cover.

6. The clamp according to claim 1, wherein the cover further comprises a component-resembling structure, and a shape and/or a height of the component-resembling structure is configured to adapt to the component.

7. The clamp according to claim 6, wherein the component-resembling structure is configured to apply pressure to the component.

8. The clamp according to claim 1, further comprising an avoidance structure, the avoidance structure being arranged on the cover and/or the carrier, the avoidance structure being configured to avoid applying pressure to the component.

9. The clamp according to claim 1, further comprising a snap hook and an engaging structure that mates with the snap hook, wherein:
the snap hook is arranged on the cover, and the engaging structure is arranged on the carrier; or
the snap hook is arranged on the carrier, and the engaging structure is arranged on the cover.

10. The clamp according to claim 1, wherein the carrier further comprises an accommodation slot, and the accommodation slot is configured to accommodate the component.

11. The clamp according to claim 1, further comprising a positioning post, the positioning post being arranged on the carrier, and the positioning post being configured to fix the component in position.

12. The clamp according to claim 1, wherein the clamp is manufactured by injection molding or 3D printing.
